(19) United States
(12) Patent Application Publication
(10) Pub. No.: US 2022/0071839 A1
(43) Pub. Date: Mar. 10, 2022

(54) SLIDING TOUCH SENSITIVE VIBRATING TOY SPEAR

(71) Applicant: Dongguan Hanjun Technology Co., Ltd., Dongguan (CN)

(72) Inventor: Ciyi Huang, Dongguan (CN)

(21) Appl. No.: 17/524,698

(22) Filed: Nov. 11, 2021

Related U.S. Application Data
(63) Continuation of application No. PCT/CN2019/125417, filed on Dec. 14, 2019.

(30) Foreign Application Priority Data
Sep. 16, 2019 (CN) 201921534951.1

(51) Int. Cl. A61H 23/02; A61H 19/00; A61H 9/00

(52) U.S. Cl. CPC A61H 23/02; A61H 19/34; A61H 2201/1215; A61H 2201/5025; A61H 2201/0153; A61H 9/0057

(57) ABSTRACT

The utility model discloses a sliding touch sensitive vibrating toy spear, comprising a handle plastic shell upper cover, wherein an inner side of the handle plastic shell upper cover is provided with a handle plastic shell lower cover, one end of the handle plastic shell upper cover is fixedly provided with a head plastic shell upper cover, an inner side of the head plastic shell upper cover is provided with a head plastic shell lower cover, one end in the handle plastic shell lower cover is provided with a master control PCB, and one side of the master control PCB board is provided with a touch sensitive sliding variable speed PCB. When being used, it is only needed to slide a finger in an area of the touch sensitive sliding variable speed PCB to adjust a vibrating speed of the product. The utility model is convenient and rapid to operate.

### TECHNICAL FIELD

The utility model relates to the technical field of adult products, in particular to a sliding touch sensitive vibrating toy spear.

### BACKGROUND

In daily life, people are busily engaged with increasing pressure, so that it is necessary to relieve pressure and relax. The break for people is very short, and therefore, many healthcare nursing products emerge in the market, for example, a vibrating spear.

The utility model with the application publication number CN206404024U discloses a vibrating spear. In the technical scheme, the vibrating spear is connected to a terminal device via a WIN module or a Bluetooth module, and the product is controlled to vibrate via the terminal device. Its principle is that the revolutions of a large motor and a small motor are controlled respectively by a microcontroller to control vibration of the product.

However, in actual use, it still has many defects, for example, the vibrating speed of the vibrating spear is adjusted remotely or via a switch button, so that it is quite inconvenient to use, and thus, the experience feeling of a user is affected.

### SUMMARY

In order to overcome the defects in the prior art, the embodiments of the utility model provide a sliding touch sensitive vibrating toy spear. By arranging the touch sensitive sliding variable speed PCB and arranging a first induction point, a second induction point and a third induction point on one side of the touch sensitive sliding variable speed PCB, when the utility mode is used, it is only needed to slide a finger in an area of the touch sensitive sliding variable speed PCB to adjust a vibrating speed of the product. The sliding touch sensitive vibrating toy spear is convenient and rapid to operate, and the experience feeling of a user is improved favorably. Therefore, the problem in the background art is solved.

In order to achieve the objective, the utility model provides a technical scheme as follows: a sliding touch sensitive vibrating toy spear includes a handle plastic shell upper cover, wherein an inner side of the handle plastic shell upper cover is provided with a handle plastic shell lower cover, one end of the handle plastic shell upper cover is fixedly provided with a head plastic shell upper cover, an inner side of the head plastic shell upper cover is provided with a head plastic shell lower cover, one end in the handle plastic shell lower cover is provided with a master control PCB, one side of the master control PCB board is provided with a touch sensitive sliding variable speed PCB, one end of the touch sensitive sliding variable speed PCB is provided with a first induction point, one side of the first induction point is provided with a second induction point, one side of the second induction point is provided with a third induction point, one end in the head plastic shell lower cover is fixedly provided with a clitoris sucking vibrating motor, one end of an output shaft of the clitoris sucking vibrating motor is fixedly connected with an eccentric coupling, a bottom end of the eccentric coupling is provided with a coupling connector, one end of the coupling connector is fixedly provided with a silica gel sucking disc, one side of the silica gel sucking disc is provided with a sucking disc fixed upper cover, the other side of the silica gel sucking disc is provide with a sucking disc fixed lower cover, and one end of the head plastic shell upper cover is fixedly provided with a silica gel head cover.

In a preferred implementation mode, the touch sensitive sliding variable speed PCB and the clitoris sucking vibrating motor are both electrically connected with the master control PCB.

In a preferred implementation mode, the sucking disc fixed upper cover and the sucking disc fixed lower cover are both fixedly connected with one side of an inner cavity of the head plastic shell lower cover.

In a preferred implementation mode, one end of the handle plastic shell upper cover is fixedly provided with a silica gel soft connector, one end of the silica gel soft connector is fixedly provided with a spear body plastic shell upper cover, an inner side of the spear body plastic shell upper cover is provided with a spear body plastic shell lower cover, and one end in a spear body plastic shell is fixedly provided with a main body motor.

In a preferred implementation mode, the main body motor is electrically connected with the master control PCB.

In a preferred implementation mode, a top end in the handle plastic shell upper cover is fixedly provided with a rechargeable battery pack, one end of the rechargeable battery pack is provided with a charging terminal, and one end of the charging terminal penetrates through the handle plastic shell upper cover.

In a preferred implementation mode, the charging terminal is electrically connected with the rechargeable battery pack, and the rechargeable battery pack is electrically connected with the master control PCB.

In a preferred implementation mode, silica gel outer sleeves sleeve the handle plastic shell upper cover, the spear body plastic shell upper cover and the silica gel soft connector externally, a space between the spear body plastic shell upper cover and each of the silica gel outer sleeves is filled with a skin-like material glue layer, and one end of each of the silica gel outer sleeves is fixedly provided with a decorative sheet.

The utility model has the beneficial effects and advantages that

compared with the prior art, by arranging the touch sensitive sliding variable speed PCB and arranging a first induction point, a second induction point and a third induction point on one side of the touch sensitive sliding variable speed PCB, when the utility mode is used, it is only needed to slide a finger in an area of the touch sensitive sliding variable speed PCB to adjust a vibrating speed of the product. The sliding touch sensitive vibrating toy spear is convenient and rapid to operate, and the experience feeling of a user is improved favorably; and

by arranging the skin-like material glue layer, the flexibility of the product may be improved, so that, the experience feeling of the product is improved favorably. Furthermore, the space between the handle plastic shell upper cover and the spear body plastic shell upper cover is provided with the silica gel soft connector, which may increase the flexibility between the spear body plastic shell upper cover and the handle plastic shell upper cover, so that the using effect of the product is improved.

### BRIEF DESCRIPTION OF THE DRAWINGS

FIG. 1 is an explosive view of an integral structure of the utility model.

FIG. 2 is a top view of the integral structure of the utility model.

FIG. 3 is an A-A section view of FIG. 2 of the utility model.

FIG. 4 is an enlarged diagram of a portion A in the FIG. 3 of the utility model.

FIG. 5 is a structural schematic diagram of a touch sensitive sliding variable speed PCB of the utility model.

FIG. 6 is a schematic diagram of a working principle of the utility model.

Numerals of the drawings: 1, master control PCB; 2, main body motor; 3, clitoris sucking vibrating motor; 4, rechargeable battery pack; 5, touch sensitive sliding variable speed PCB; 6, charging terminal; 7, silica gel soft connector; 8, skin-like material glue layer; 9, silica gel sucking disc; 10, eccentric coupling; 11, silica gel head sleeve; 12, sucking disc fixed lower cover; 13, sucking disc fixed upper cover; 14, coupling connector; 15, head plastic shell lower cover; 16, spear body plastic shell upper cover; 17, spear body plastic shell lower cover; 18, head plastic shell upper cover; 19, handle plastic shell lower cover; 20, handle plastic shell upper cover; 21, silica gel outer sleeve; 22, decorative sheet; 23, first induction point; 24, second induction point; 25, third induction point.

### DETAILED DESCRIPTION

Clear and intact description will be made on technical scheme in the embodiment of the utility model below in combination with drawings in the embodiment of the utility model. The described embodiments are merely a part of embodiments of the utility model and are not all the embodiments. On a basis of the embodiments in the utility model, all other embodiments obtained by those skilled in the technical field without creative efforts fall into the scope of protection of the utility model.

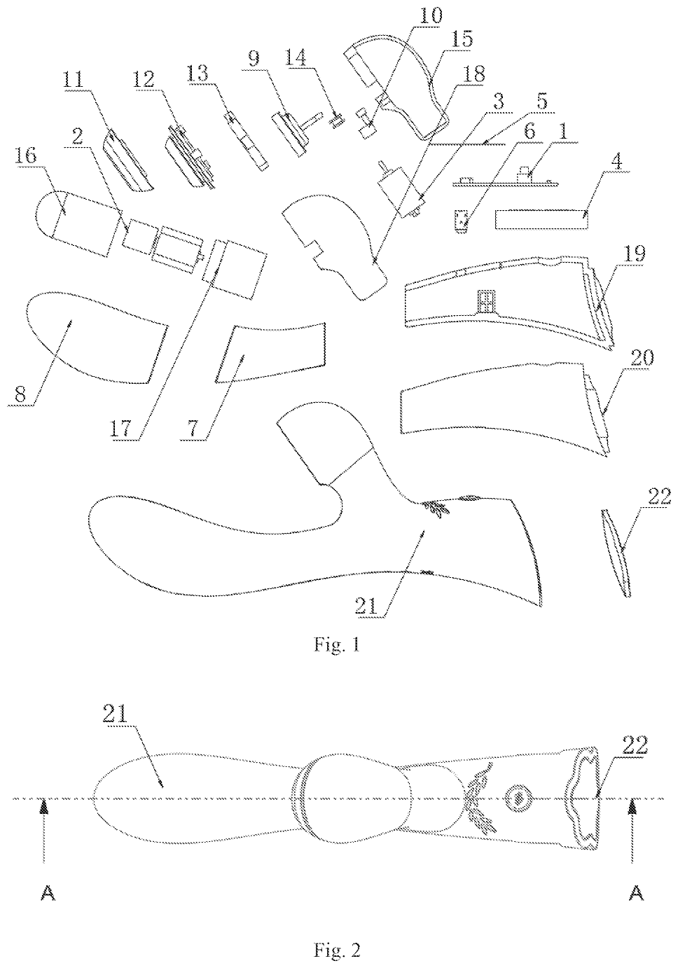

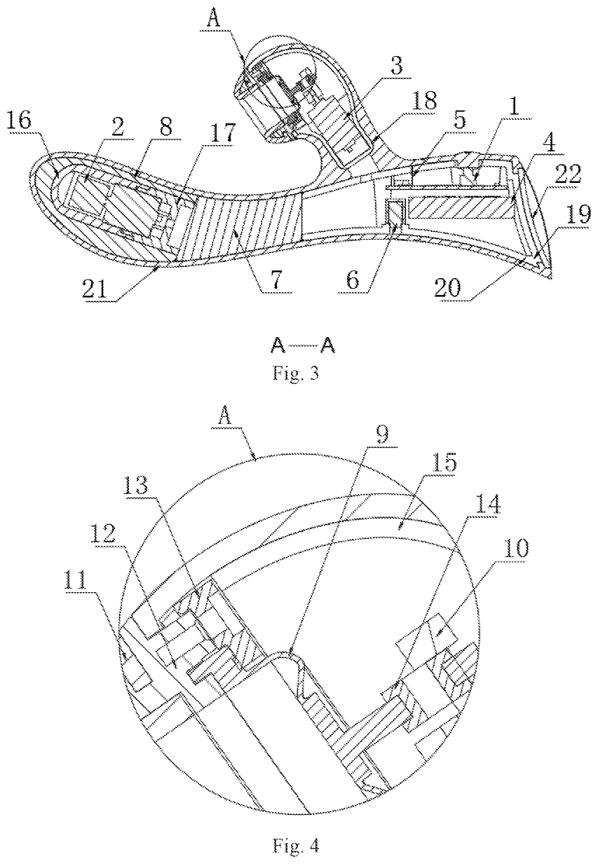

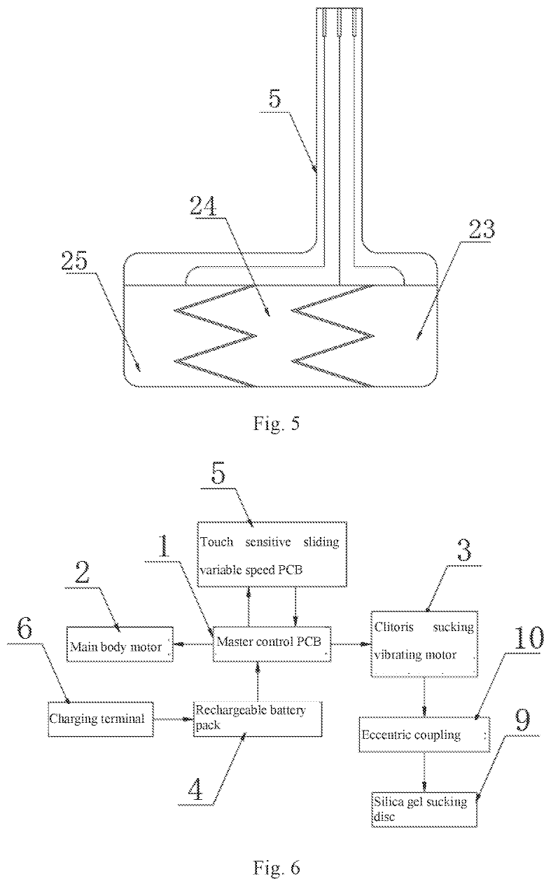

A sliding touch sensitive vibrating toy spear as shown in FIG. 1 to FIG. 6 includes a handle plastic shell upper cover 20, wherein an inner side of the handle plastic shell upper cover 20 is provided with a handle plastic shell lower cover 19, one end of the handle plastic shell upper cover 20 is fixedly provided with a head plastic shell upper cover 18, an inner side of the head plastic shell upper cover 18 is provided with a head plastic shell lower cover 15, one end in the handle plastic shell lower cover 19 is provided with a master control PCB 1, one side of the master control PCB board 1 is provided with a touch sensitive sliding variable speed PCB 5, one end of the touch sensitive sliding variable speed PCB 5 is provided with a first induction point 23, one side of the first induction point 23 is provided with a second induction point 24, one side of the second induction point 24 is provided with a third induction point 25, one end in the head plastic shell lower cover 15 is fixedly provided with a clitoris sucking vibrating motor 3, one end of an output shaft of the clitoris sucking vibrating motor 3 is fixedly connected with an eccentric coupling 10, a bottom end of the eccentric coupling 10 is provided with a coupling connector 14, one end of the coupling connector 14 is fixedly provided with a silica gel sucking disc 9, one side of the silica gel sucking disc 9 is provided with a sucking disc fixed upper cover 13, the other side of the silica gel sucking disc 9 is provide with a sucking disc fixed lower cover 12, and one end of the head plastic shell upper cover 18 is fixedly provided with a silica gel head cover 11;

the touch sensitive sliding variable speed PCB 5 and the clitoris sucking vibrating motor 3 are both electrically connected with the master control PCB 1;

the sucking disc fixed upper cover 13 and the sucking disc fixed lower cover 12 are both fixedly connected with one side of an inner cavity of the head plastic shell lower cover 15;

one end of the handle plastic shell upper cover 20 is fixedly provided with a silica gel soft connector 7, one end of the silica gel soft connector 7 is fixedly provided with a spear body plastic shell upper cover 16, an inner side of the spear body plastic shell upper cover 16 is provided with a spear body plastic shell lower cover 17, and one end in a spear body plastic shell is fixedly provided with a main body motor 2;

the main body motor 2 is electrically connected with the master control PCB 1;

a top end in the handle plastic shell upper cover 19 is fixedly provided with a rechargeable battery pack 4, one end of the rechargeable battery pack 4 is provided with a charging terminal 6, and one end of the charging terminal 6 penetrates through the handle plastic shell upper cover 20;

the charging terminal 6 is electrically connected with the rechargeable battery pack 4, and the rechargeable battery pack 4 is electrically connected with the master control PCB 1;

silica gel outer sleeves 21 sleeve the handle plastic shell upper cover 20, the spear body plastic shell upper cover 16 and the silica gel soft connector 7 externally, a space between the spear body plastic shell upper cover 16 and each of the silica gel outer sleeves 21 is filled with a skin-like material glue layer 8, and one end of each of the silica gel outer sleeves 21 is fixedly provided with a decorative sheet 22.

A specific implementation mode is as follows: before use, the product is filled with electricity; during use, the vibrating speed of the product is adjusted according to a using demand; when the vibrating speed is adjusted, a finger slides on the area of the touch sensitive sliding variable speed PCB 5, and when the finger slides at the first induction point 23, the second induction point 24 and the third induction point 25, the vibrating speed of the product is increased gradually. When the finger slides at the third induction point 25, the second induction point 24 and the first induction point 23 successively, the vibrating speed of the product may be decreased gradually. Furthermore, the touch sensitive sliding variable speed PCB 5 will record a functional speed mode that is used by a user for the later time after turn off, so that the product is conveniently used for the next time.

In the vibrating speed adjusting process of the product, under control of the master control PCB 1, the clitoris sucking vibrating motor 3 works and the clitoris sucking vibrating motor 3 drives the eccentric coupling 10 and the silica gel sucking disc 9 to perform a rotating motion. Conducted and driven by the eccentric coupling 10, the silica gel sucking disc 9 moves in a reciprocated push and pull manner, so that a pulsed sucking vibrating effect is generated in a cavity space of the head of the product, and furthermore, as a vibration sucking area and the spear body are separated and the silica gel leather sleeve in the outer layer is soft, when the vibration sucking area is placed in the outer leather sleeve, the product may deform and may be adjusted, in angle due to elasticity of the silica gel leather sleeve, so that the experience feeling of the product is improved.

By arranging the touch sensitive sliding variable speed PCB 5 and arranging a first induction point 23, a second induction point 24 and a third induction point 25 on one side of the touch sensitive sliding variable speed PCB 5, when the utility mode is used, it is only needed to slide a finger in an area of the touch sensitive sliding variable speed PCB 5 to adjust a vibrating; speed of the product. The sliding touch sensitive vibrating toy spear is convenient and rapid to operate, and the experience feeling of a user is improved favorably. Furthermore, as the skin-like material glue layer 8 is arranged, the flexibility of the product may be improved, and the experience feeling of the product is improved favorably.

Furthermore, the space between the handle plastic shell upper cover 20 and the spear body plastic shell upper cover 16 is provided with the silica gel soft connector 7, which may increase the flexibility between the spear body plastic shell upper cover 16 and the handle plastic shell upper cover 20, so that the using effect of the product is improved. The implementation mode specifically solves the problem that the product is quite inconvenient to use, and thus, the experience feeling of a user is affected as the vibrating speed of the vibrating spear is adjusted remotely or via a switch button.

The working principle of the utility model is as follows:

Referring to FIG. 1 to FIG. 6 of the description, during use, the vibrating speed of the product is adjusted according to a using demand. Meanwhile, under control of the master control PCB 1, the clitoris sucking vibrating motor 3 works and drives the silica gel sucking disc 9 to rotate via the eccentric coupling 10 and the coupling connector 14, so that a pulsed sucking vibrating effect is generated in a cavity space of the head of the product.

By arranging the touch sensitive sliding variable speed PCB 5 and arranging a first induction point 23, a second induction point 24 and a third induction point 25 on one side of the touch sensitive sliding variable speed PCB 5, when the utility mode is used, it is only needed to slide a finger in an area of the touch sensitive sliding variable speed PCB 5 to adjust a vibrating speed of the product. The sliding touch sensitive vibrating toy spear is convenient and rapid to operate, and the experience feeling of a user is improved favorably. Furthermore, as the skin-like material glue layer S is arranged, the flexibility of the product may be improved, and the experience feeling of the product is improved favorably. Furthermore, the space between the handle plastic shell upper cover 20 and the spear body plastic shell upper cover 16 is provided with the silica gel soft connector 7, which may increase the flexibility between the spear body plastic shell upper cover 16 and the handle plastic shell upper cover 20, so that the using effect of the product is improved.

It is to be noted finally that first, in the description of the application, it is noted that unless otherwise specified, terms “mount”, “interconnect” and “connect” shall be understood in a broad sense, which may be mechanic connection or electrical connection, or communication in two elements, and direct connection; “upper”, “lower”, “left”, “right” and the like are merely used to represent a relative position relation. When the absolute position of a described object is changed, the relative position relation may change;

second, in the drawings of the embodiments of the utility model, structures in the embodiments are mentioned only, and other structure may be seen in usual design. The same embodiment of the utility model may be combined with different embodiments without conflicts; and

finally, the above is merely the preferred embodiments of the utility model and is not used to limit the utility mode. Any modifications, equivalent substitutions, improvements and the like made within the spirit and principle of the utility model shall fall within the scope of protection of the utility model.

1. A sliding touch sensitive vibrating toy spear, comprising a handle plastic shell upper cover, wherein an inner side of the handle plastic shell upper cover is provided with a handle plastic shell lower cover, one end of the handle plastic shell upper cover is fixedly provided with a head plastic shell upper cover, an inner side of the head plastic shell upper cover is provided with a head plastic shell lower cover, one end in the handle plastic shell lower cover is provided with a master control PCB, one side of the master control PCB board is provided with a touch sensitive sliding variable speed PCB, one end of the touch sensitive sliding variable speed PCB is provided with a first induction point, one side of the first induction point is provided with a second induction point, one side of the second induction point is provided with a third induction point, one end in the head plastic shell lower cover is fixedly provided with a clitoris sucking vibrating motor, one end of an output shaft of the clitoris sucking vibrating motor is fixedly connected with an eccentric coupling, a bottom end of the eccentric coupling is provided with a coupling connector, one end of the coupling connector is fixedly provided with a silica gel sucking disc, one side of the silica gel sucking disc is provided with a sucking disc fixed upper cover, the other side of the silica gel sucking disc is provide with a sucking disc fixed lower cover, and one end of the head plastic shell upper cover is fixedly provided with a silica gel head cover.

2. The sliding touch sensitive vibrating toy spear according to claim 1, wherein the touch sensitive sliding variable speed PCB and the clitoris sucking vibrating motor are both electrically connected with the master control PCB.

3. The sliding touch sensitive vibrating toy spear according to claim 1, wherein the sucking disc fixed upper cover and the sucking disc fixed lower cover are both fixedly connected with one side of an inner cavity of the head plastic shell lower cover.

4. The sliding touch sensitive vibrating toy spear according to claim 1, wherein one end of the handle plastic shell upper cover is fixedly provided with a silica gel soft connector, one end of the silica gel soft connector is fixedly provided with a spear body plastic shell upper cover, an inner side of the spear body plastic shell upper cover is provided with a spear body plastic shell lower cover, and one end in a spear body plastic shell is fixedly provided with a main body motor.

5. The sliding touch sensitive vibrating toy spear according to claim 4, wherein the main body motor is electrically connected with the master control PCB.

6. The sliding touch sensitive vibrating toy spear according to claim 1, wherein a top end in the handle plastic shell upper cover is fixedly provided with a rechargeable battery pack, one end of the rechargeable battery pack is provided with a charging terminal, and one end of the charging terminal penetrates through the handle plastic shell upper cover.

7. The sliding touch sensitive vibrating toy spear according to claim 6, wherein the charging terminal is electrically connected with the rechargeable battery pack, and the rechargeable battery pack is electrically connected with the master control PCB.

8. The sliding touch sensitive vibrating toy spear according to claim 1, wherein silica gel outer sleeves sleeve the handle plastic shell upper cover, the spear body plastic shell upper cover and the silica gel soft connector externally, a space between the spear body plastic shell upper cover and each of the silica gel outer sleeves is filled with a skin-like material glue layer, and one end of each of the silica gel outer sleeves is fixedly provided with a decorative sheet.
